(19) United States
(12) Patent Application Publication
(10) Pub. No.: US 2002/0191866 A1
(43) Pub. Date: Dec. 19, 2002

(54) Image signal processing system

(76) Inventor: Kazuhiro Tanabe, Iruma (JP)

Correspondence Address: ANTONELLI TERRY STOUT AND KRAUS, SUITE 1800, 1300 NORTH SEVENTEENTH STREET, ARLINGTON, VA, 22209

(21) Appl. No.: 10/166,248

(22) Filed: Jun. 11, 2002

(30) Foreign Application Priority Data
Jun. 13, 2001 (JP) 2001-179408

(51) Int. Cl. G06K 9/32

(52) U.S. Cl. 382/298

(57) ABSTRACT

An image signal processing system for processing image signal produced from a camera is provided that has an image sensor having a first number of effective pixels, and signal processors for processing the image signal of the first number of effective pixels from the image sensor to produce another image signal of a second number of effective pixels less than the first number of effective pixels, wherein the signal processors include a zooming-in processor for taking out the image signal of the second number of effective pixels as partial image regions specified within the image signal of the first number of effective pixels, and outputting it at a predetermined output rate.

### BACKGROUND OF THE INVENTION

The present invention relates to an improved image signal processing suitable for a video surveillance system mainly using video cameras.

The recent video cameras have an electrically zooming-in (or magnifying) function incorporated. That is, a partial image is cut from the image produced from an image pickup device (image sensor) such as CCD, and the data of the partial image is processed by using a memory to change the time base so that the image can be expanded. The image data decreased in the density of its pixels by the extension of the time base is subjected to an electrical interpolation processing in order to compensate for the data, and the interpolation processed data is output at a predetermined data rate.

FIG. 5 shows the concept of this electrical zooming-in processing. As illustrated, a partial image region cut from the image on the image sensor undergoes electrical fourfold zooming-in processing. Here, the image read from the sensor is assumed to have 640 horizontal pixels and 480 vertical lines.

The fourfold zooming-in generally corresponds to the twofold magnification of each of the horizontal and vertical directions. In other words, an image range of, for example, 320 horizontal pixels and 240 vertical lines is cut from the sensor output image, and electrically magnified.

Here, we consider the resolution of image (the quality of finess of image, fundamentally determined by the pitch at which the sensor output is sampled) in the electrical zooming-in operation. When the horizontal image data of the sensor is directly read out without any change, the horizontal resolution is 640-pixel pitch. Even if an image region of 320 horizontal pixels is tried to cut away and magnified twofold for 640-pixel pitch after interpolation, the actual resolution remains only half the pitch, or 320 pixels. In other words, zooming-in will result in deterioration of effective resolution. Thus, when the partial image cut from the image on the sensor is electrically zoomed in, the apparent pitch of pixels after zooming-in is not different from the pitch of pixels of the image on the sensor, but the resolution is deteriorated because the image of half the pixel number (320 pixels) is simply expanded.

On the other hand, when the partial image region is zoomed in fourfold by using an optical system, the resolution is not reduced because the number of pixels of this region after optical magnification is the same as that of the photosensitive region of the sensor (640 pixels). However, the range of image to be picked up by the sensor is limited to the optically zoomed-in image portion (in this example, the partial central-region image of 320 horizontal pixels and 240 vertical lines).

Therefore, when the user wants to select an arbitrary region from a wide range of image and to zoom in, it is difficult to use an optical system for zooming-in of such arbitrary region, and thus the user is obliged to select the electrical zooming-in processing.

In addition, recently, a sensor of over a million pixels has appeared. On the other hand, when the output of a video camera is reproduced on the monitor screen of a personal computer, the screen called VGA (Video Graphics Array) size can satisfactorily display signals or image data of 640 horizontal pixels and 480 vertical lines, or about 310 thousand pixels (640×480) per frame. The screen called SXGA (Super extended Graphics Array) size can reproduce a signal of 1280 horizontal pixels and 1024 vertical lines, or about 1300 thousand pixels per frame. In addition, the screen called VXGA size can reproduce a signal of 1600 horizontal pixels and 1200 vertical lines, or 1920 thousand pixels per frame.

These sensors of over a million pixels are used for still cameras that pick up still images, and for industrial cameras that supply high-quality images to a personal computer on which to judge, recognize and process the image.

Under these situations, video surveillance systems using a network generally can accept, as a signal from the video camera, only image data of less than VGA size indicating the effective number of pixels per frame because the transmission path of the network has a limited possible transmission rate. In this case, also the image data is compressed, and the frames of the image data are thinned out (or the image data (frames) to be transmitted per second are thinned out so that the number of frames can be decreased) in order that data can be sent at a reduced transmission rate.

The image of VXGA size can also be transmitted in theory by increasing the data rate of the transmission path. Under the present circumstances, however, the users in the fields of video surveillance system think that the VGA size has enough resolution, and preferably want to receive at the user's side as many surveillance camera images as possible without compression and thinning-out of frames if possible. Therefore, even if image data were picked up by a sensor of larger image size than necessary, the most part of the amount of information would be discarded when the image data is fed to the network, and hence sensors of less than VGA size are normally used.

We nowadays see a video camera of the type in which a pan and tilt facility is incorporated to allow the camera to freely change the field of view. Use of this camera will make wide-range surveillance and observation possible when the orientations of camera are sequentially switched in a predetermined order, but the system becomes expensive.

As described above, the conventional video camera system has the demerit that the electrical zooming-in function deteriorates the resolution of image when the image is zoomed in.

### SUMMARY OF THE INVENTION

It is an object of the invention to construct a video camera system with the above drawbacks removed by using an electrical zooming-in function to monitor images over a wide range without deteriorating the picture quality even in the zoom-in operation.

In order to achieve the above object, according to the invention, there is provided an image processing system for processing image signal from a camera, the system having an image sensor with a first number of effective dots, or pixels, and signal processors for processing an image signal of the first number of effective pixels from the image sensor to produce another image signal of a second number of effective pixels less than the first number of effective pixels, the signal processors including a zooming-in processor for taking out the image signal of the second number of effective pixels as a partial image region specified within the image signal of the first number of effective pixels, and outputting it at a predetermined output rate.

In addition, according to the invention, there is provided an image signal processing system connected to a communication network, the system having an image sensor with a first number of effective pixels, and signal processors for processing an image signal of a second number of effective pixels from the image sensor to produce another image signal of a second number of effective pixels less than the first number of effective pixels, and supplying it to the communication network, the signal processors including a zooming-in processor for taking out the image signal of the second number of effective pixels as a specified partial image region from the image signal of the first number of effective pixels, and supplying it at a certain output rate, a thinning-out processor for sampling the image signal of the first number of effective pixels at a predetermined sampling rate to produce the image signal of the second number of effective pixels, and outputting it, and a selector for selecting either one of the output from the thinning-out processor and the output from the zooming-in processor by switching in response to a selection signal received by an external terminal device connected to the communication network.

Thus, the picture quality in an image signal processing system provided according to the embodiments of the invention can be improved to be less deteriorated, under the considerations that large-size image sensors having a large number of pixels are available and that the network has a limited transmission rate, by employing an image sensor having a large number of effective pixels and properly switching the thinning-out processing and electrically zooming-in processing of this sensor output.

For example, the image data supplied from the video camera to the outside or a network is kept to be VGA size (640×480) as an effective pixel number, and the image sensor is selected to have SXGA size (1280×1024). The resolution of SXGA size image data is twice as large as that of VGA size image data in both horizontal and vertical directions, and thus the amount of information that the SXGA size image data has is four times as large.

Thus, in sending of normal image data, the output from the SXGA size sensor is thinned out to produce VGA size image data, which is then supplied to the outside or a network. In this case, the horizontal and vertical resolutions are not twice as large as VGA size, but the image of the whole region of the imaging screen of the SXGA size sensor and having the resolution equivalent to the VGA size can be obtained.

In the case of transmitting the electrically zoomed-in image, for example, a fourfold zoomed-in image, a desired image portion of VGA size (640×480) is cut from the whole image area of SXGA size (1280×1024) produced from the image sensor, and zoomed in fourfold. At this time, the size of the cut portion is 1280÷2=640 horizontal pixels, 1024÷2=512 vertical lines, and thus has the resolution equivalent to VGA size.

In other words, according to the invention, the resolution of the image from whole image area after thinning out processing becomes equivalent to that of the cut image portion from the image area after electrically zooming-in processing. Accordingly, a video surveillance system having an electric zooming-in function to make it possible to monitor a wide range of scene can be constructed, which can prevent the picture quality from being deteriorated by, if necessary, switching the thinned-out image resulting from thinning out the whole image from the sensor and the zoomed-in image resulting from zooming in the cut image portion that is cut from the whole image.

Other objects, features and advantages of the invention will become apparent from the following description of the embodiments of the invention taken in conjunction with the accompanying drawings.

### BRIEF DESCRIPTION OF THE DRAWINGS

FIG. 1 is a schematic diagram to which reference is made in explaining the relation between the image sensor output and camera output in the thinning-out processing and electric zooming-in processing made by an embodiment of an image signal processing system according to the invention.

FIG. 2A is a diagram to which reference is made in explaining the thinning-out of the image signal of one horizontal line.

FIG. 2B is a diagram to which reference is made in explaining the twofold zooming-in of the image signal of one horizontal line.

FIG. 2C is a diagram to which reference is made in explaining the four-fold zooming-in of the image signal of one horizontal line.

FIG. 3 is a block diagram of the construction of an embodiment of a video surveillance system using an image signal processing system according to the invention and a network.

FIG. 4 is a schematic diagram useful for explaining a method of transmitting an image signal of SXGA size by use of an image signal processing system according to the invention.

FIG. 5 is a schematic diagram useful for explaining the relation between the image sensor output and camera output in the conventional thinning-out processing and electric zooming-in processing.

### DESCRIPTION OF THE EMBODIMENTS

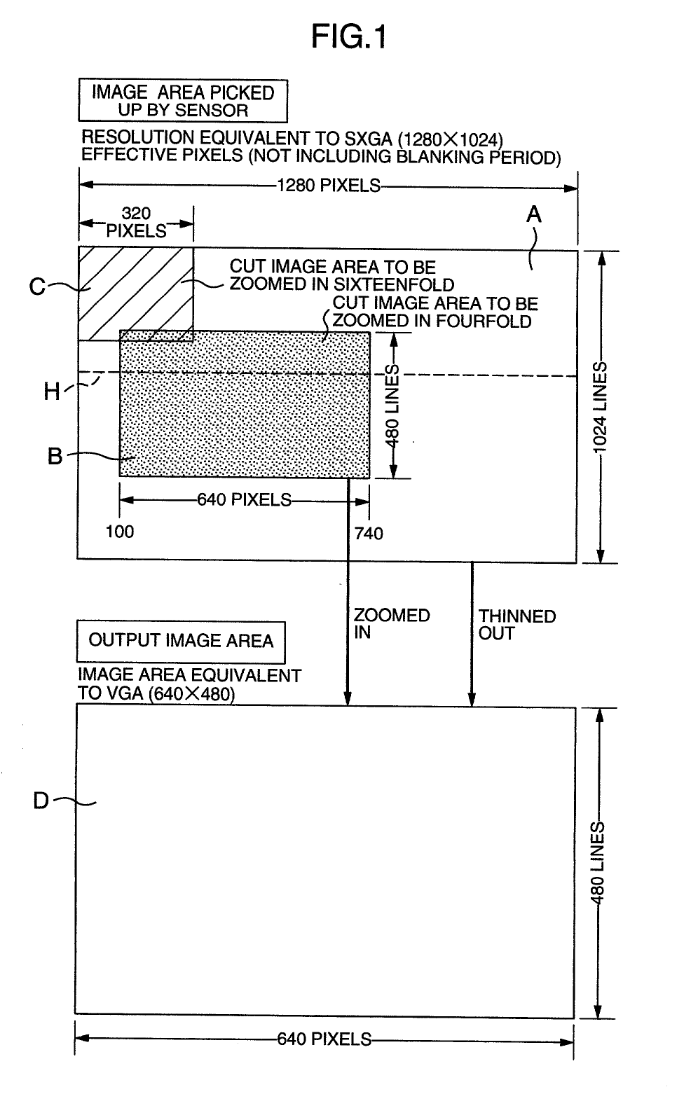

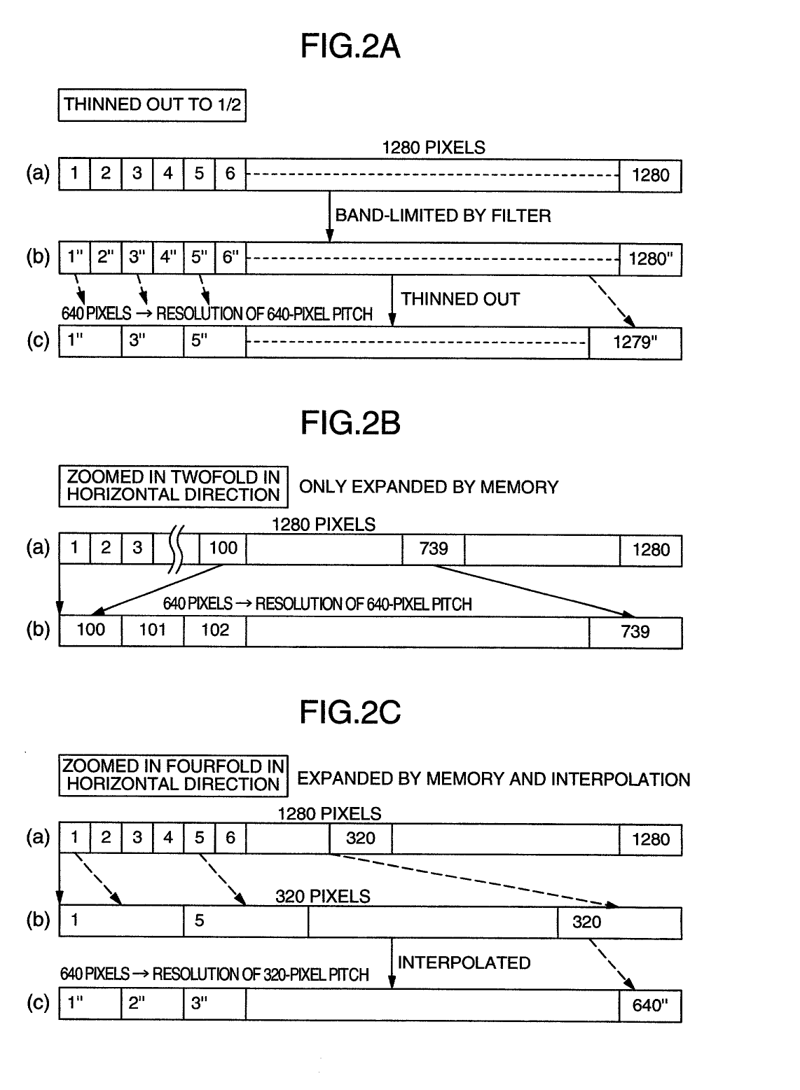

With reference to FIG. 1 and FIGS. 2A, 2B and 2C, a description will be made of one embodiment of an image data processing system according to the invention that properly switches the thinning-out processing and electric zooming-in processing of images to produce an output.

FIG. 1 is a schematic diagram showing the relation between the images resulting from the thinning-out processing and electric zooming-in processing of the image data produced from an image sensor. FIGS. 2A, 2B and 2C are timing charts for the thinning-out processing and electric zooming-in processing.

Here, the image sensor used is of SXGA size (1280×1024), and the size of the image data produced from this image data processing system is assumed to be VGA size (640×480). Also, it is here assumed that fourfold zooming-in operation is made on the image data. In other words, when we consider that a partial image B of the whole image area A from the image sensor is zoomed in for its horizontal pixel number and vertical line number to be increased twice, the partial image B has ½ the 1280 horizontal pixels and vertical 1024 lines of the SXGA size, or 640 horizontal pixels and 512 vertical lines.

That is, the VGA size that has 640 horizontal pixels and 480 vertical lines has the amount of information corresponding to about ¼ the SXGA size.

First, a description will be made of the image produced from an image data processing system according to the invention when a video surveillance system using this system is operated in the standard surveillance mode in which the zooming-in operation is not made.

In the standard surveillance mode, the amount of information (1.3 million pixels) of SXGA size produced from the image sensor is thinned out to ¼ as large, or the amount of information (310 thousand pixels) corresponding to the VGA size, and then supplied to the display monitor or the network. In other words, the amount of information of at least 310 thousand pixels which the image data has is often sufficient for the normal video surveillance system to satisfactorily play its role in the standard surveillance mode.

The procedure for this thinning-out operation will be described with reference to FIG. 2A. FIG. 2A shows the thinning-out operation for reducing an amount of image signal of one horizontal line (1280 pixels) to ½ as large as that pixel number, or to 640 pixels per line. The output signal of SXGA size from the image sensor as shown in FIG. 2A at (a) is converted to a digital signal by A/D conversion, and then caused to pass through a filter in order to prevent the aliasing noise, thereby its frequency band being limited (FIG. 2A, (b)). As a result, the frequency components higher than ¼ the sampling frequency that will be used in the next thinning-out process are removed from the image signal. Then, the image signal (b) is sampled at every other pixels, resulting in the generation of an image signal (c) of 640 pixels per line.

Consequently, the horizontal resolution becomes a pitch of 640 pixels, and the amount of information in the horizontal direction is also 640 pixels. If the effect of the aliasing noise components can be neglected, the process using the filter can be omitted so that the image signal (a) from the sensor can be directly thinned out. In addition, the image signal of vertical lines can be similarly thinned out, resulting in the generation of an image area D (FIG. 1) of 640 pixels ×480 lines of the whole image area. This image area D is the standard surveillance image.

The image produced in the zooming-in operation will be described. In the zooming-in operation, the image area B of VGA size (640×480) is cut from the image area A of SXGA size (1280×1024), and magnified fourfold. The zooming-in is performed by extending the time base in a memory. FIG. 2B shows the concept of this zoom-in process.

The partially cutting process and zooming-in process will be described. The desired partial image B of the whole image A in FIG. 1 can be magnified fourfold by making twofold zoom-in processing on the horizontal and vertical data of the partial image B. FIG. 2B shows the twofold zoom-in of the range from the hundred pixel to the 739th pixel of a horizontal line (1280 pixels) as counted from the leftmost pixel. The image signal (a) in FIG. 2B is a horizontal line (1280 pixels) indicated by a dotted line H within the image A of SXGA size produced from the image sensor in FIG. 1. The horizontal line H also includes any one of the horizontal lines of the partial image B being cut away. First, the positional information of where the partial image B is cut away is selected. This positional information is indicated by the positions of pixels based on the horizontal and vertical synchronizing signals of the whole image signal A.

The cut positions are arbitrarily specified by the user. When the cut positions are fixed, they are set beforehand. The arbitrarily specified or previously set cut positions are read in by a CPU which will be described later, and converted to the positional information based on the synchronizing signals. The CPU controls the memory to read and write on the basis of the positional pixel information. As illustrated in FIG. 2B, if the image signal having a range of the hundred pixel to 739th pixel of the horizontal line (1280 pixels) A when counted from the leftmost pixel is written in the memory, and then read from the memory at a clock rate of ½ the write clock rate, a magnified image signal of 640 pixels per line can be obtained as shown in FIG. 2B at (b). This operation is repeated for all horizontal lines of partial image B, thus producing a zoomed-in image as a horizontally twofold image. Here, the twofold zoom-in process for the vertical direction is also similarly made to produce a fourfold zoomed-in image as the whole image area.

From the comparison between the standard-mode image (thinned-out image) and the fourfold zoomed-in image, it will be understood that the amounts of information or resolutions of both images are equal. Therefore, even if the cut image is subjected to the electric zoom-in process, its picture quality can be prevented from being deteriorated as compared with the standard surveillance mode image.

An example of a higher zoom-in ratio will be described with reference to FIG. 2C.

To zoom in fourfold in the direction of horizontal line, a range of 320 pixels per line as a partial image C is cut from the image area A having a pitch of 1280 pixels (FIG. 2C at (b)), written in the memory and then sampled at every fifth pixels to read from the memory at a pitch of 320 pixels, so that the cut image can be extended fourfold in the time base direction as shown in FIG. 2C at (b). In this case, the image size is equivalent to the 1280-pixel size, but, the amount of information is 320 pixels. Then, the extended output image is subjected to pixel interpolation processing because it is required to process at a pitch of 640 pixels so that each horizontal line includes 640 pixels. Thus, image data generated by the interpolation processing is added to the signal of 320 pixels to form a signal of 640 pixels as shown in FIG. 2C at (c). In this case, although the amount of signal is 640 pixels, the resolution remains a pitch of 320 pixels. In addition, if the vertical lines are similarly subjected to the same fourfold zoom-in processing and interpolation processing as the horizontal pixels per line, a sixteenfold zoomed-in image can be produced as a complete image. Moreover, when the zooming factor for horizontal direction is less than 2, the interpolation processing is also required in addition to the horizontal extension using the memory.

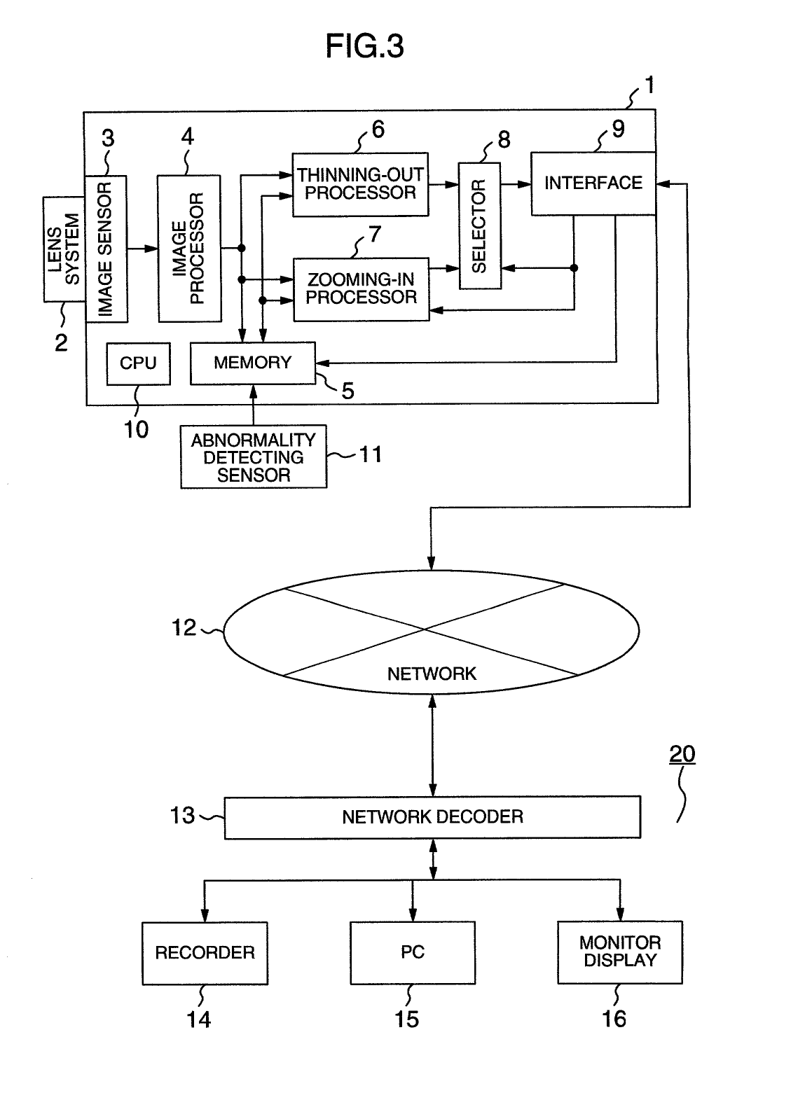

Next, with reference to FIG. 3, a description will be made of the construction of a video surveillance system using a network as a second embodiment of the invention to which the image signal processing system of the first embodiment is applied.

Referring to FIG. 3, there are shown a video camera 1 (hereafter, referred to simply as the camera) including the image signal processing system, an optical system 2 such as a lens system, an image sensor 3, a camera-use image processor 4, a memory 5, a thinning-out processor 6, a zooming-in processor 7, a selector 8, a network interface 9, a CPU 10 for controlling each element within the camera 1, and a sensor 11 that detects an abnormal thing occurring in the place being subject to surveillance to generate an alarm signal, such as a general alarm device using infrared light. In addition, there are shown a network 12, a network decoder 13, a recorder 14, a personal computer 15, and a display monitor 16. The camera-use image processor 4 is a well known circuit device that amplifies a signal produced from the image sensor 2, samples it at a predetermined rate, and converts it to a digital signal. Also, this processor 4 makes color compensation (masking), luminance correction (knee correction, gamma correction), frequency characteristic correction (enhancer), and matrix processing (YC format) to the digital image signal.

The image passed through the optical system 2 and formed on the photosensitive surface of the image sensor 3 by the optical system 2 is sampled by the sensor 3 to produce an electric signal. The image area size of the sensor used here is the same SXGA size (1280×1024) as in the first embodiment.

The image signal from the sensor 3 is processed by the camera-use image processor 4, and then fed to the thinning-out processor 6 and to the zooming-in processor 7.

In the standard surveillance mode, the amount of information of the image signal (1.3 million pixels) of SXGA size is thinned out to ¼ as large, or reduced to VGA size corresponding to the amount of information of the image signal (0.31 million pixels). In practice, the size-reduced image signal is normally subjected to compression and thinning-out of frames (the number of frames per second is reduced so that the transmission rate can be decreased), thus reduced in its transmission rate before it is transmitted.

Although increasing the transmission rate on the transmission path can make the SXGA-size image signal be transmitted in principle, the image area size VGA suffices the video surveillance system, and as many images as possible from cameras should be received preferably without compression and thinning-out of frames.

Therefore, because the most part of the information of an image, even if it is produced by using a needlessly larger area size sensor, is discarded when the image signal is fed to the network, use of even VGA size or less will make it possible to satisfy the user's requirement.

In the standard monitoring mode, the thinned-out image signal with its information reduced to ¼ (, or to ½ as large as horizontal, ½ as large as vertical) from the processor 6 is selected by the selector 8, and supplied via the network interface 9 from the camera 1 to the outside. The image signal from the camera 1 is supplied to the network 12, and received by a terminal 20 connected to the network 12.

In this terminal 20, the network decoder 13 receives the signal, the recorder 14 records it, the personal computer 15 processes the image signal, and the monitor display 16 displays the image being monitored.

Thus, the user can visually confirm on the monitor 16 the image received by the network decoder 13. When a part of the image area displayed on the monitor 16 is desired to zoom in, for example, when the user finds a trespasser and wants to shoot a close-up of a trespasser's face, the user operates the personal computer 15 to specify the cut position and send the position information and the instruction to zoom in via the network 12 to the camera 1.

In the camera 1, the selector 8 is controlled to select the output from the zooming-in processor 7 in response to the instruction to zoom in received from the terminal 20 via the network 12, and the received cut position information is fed to the zooming-in processor 7.

When the camera 1 receives the instruction to zoom in, the zooming-in processor 7 zooms in the image according to the instruction. Here, if the zoom-in magnification is selected to be four, a partial image (0.31 million pixels) corresponding to VGA size (640×480) of ¼ SXGA size is cut from the SXGA-size image area (1.30 million pixels), and extended to the standard image area size by using the memory. This processing is equivalent to that mentioned in the first embodiment. Here, the amount of information is 0.31 million pixels, and thus equivalent to that in the standard surveillance mode. In addition, the resolution is the same as in the standard surveillance mode.

The fourfold zoomed-in signal from the zooming-in processor 7 is selected by the selector 8, and supplied through the network interface 9 from the camera 1 to the outside. The signal from the camera 1 is fed to the network 12, and received by the terminal 20 connected to the network 12. In the terminal 20, the received signal is displayed on the monitor 16, and at the same time recorded by the recorder 14.

The image displayed on the monitor 16, although it results from electric zoom-in processing, has the resolution equivalent to that in the standard monitoring mode, and thus can be confirmed as a clear image.

If the zooming-in magnification in the horizontal direction is selected to four (including the case in which the magnification in both horizontal and vertical directions is four) as shown in FIG. 2C, the circuits for performing the above interpolation processing is provided in the zooming-in processor 7.

In the conventional system, the close-up image of the trespasser's face obtained by the electric zooming-in appears so deteriorated and unclear as compared with the original image that it is not satisfactory enough to see the features of it. The system using the construction according to the invention can prevent the resolution from being degraded as compared with the normal surveillance image, thus simply producing clear detailed images.

The third embodiment using a skipping-back function in the network-type video surveillance system will be described with reference to FIG. 3. The memory shown in FIG. 3 is used to hold the data for skipping-back. The memory 5 for skipping back has a function to record only the image signals in a predetermined number of successive frames, and bring the earliest frame as the current frame of image.

The skipping-back function will first be described in brief. Under this skipping-back function, the images, or pictures produced from the camera 1 are always cyclically recorded in the memory 5 that is capable of storing a plurality of pictures (a plurality of fields or frames), and when a particular condition occurs, for example, when a trespasser is detected, an alarm signal is generated and used as a trigger to cause the memory 5 having a plurality of frames recorded to skip over those frames and start reading the earliest frame and the following frames in turn. Therefore, the previous images, before the alarm occurs, or just before the trespasser is going to enter, can be reproduced, thus making it possible to observe the previous action of the trespasser. Here, the skipped-back images are assumed to be stored in the memory 5.

As in the second embodiment, the picked-up image from the camera 1 is sampled by the image sensor 3 to be converted to an electric signal. The image sensor 3 is assumed to have the size of SXGA (1280×1024).

The image signal from the image sensor 3 is processed by the camera-use image processor 4, and supplied to the thinning-out processor 6 and to the zooming-in processor 7. At the same time, it is fed to the skipping-back memory 5.

When an alarm signal is generated from the abnormal condition detecting sensor 11, it is used as a trigger to actuate the memory 5 to make the skipping-back operation. At this time, the memory 5 holds the image signals of a plurality of pictures previously recorded before the trigger generation.

The information of this alarm occurrence is transmitted through the network 12 to the receiving terminal 20, where the user knows this information.

When becoming aware of the alarm, the user sends a skip-back instruction via the network 12 to the camera 1 to order the camera 1 to switch from the standard surveillance mode image to the skipped-back image, or the earliest, previous image.

The camera 1 that has received the instruction to switch to this skipped-back image stops the production of the standard monitoring image signal and starts to produce the signal that results from processing the output from the skipping-back memory 5. The skipped-back image recorded in the memory 5 has the SXGA size.

This skipped-back image signal is first thinned out by the processor 6 to an extent of ¼ as is the standard monitoring image signal, and then supplied as a VGA size signal from the camera 1 via the selector 8 and network interface 9 to the outside.

The signal fed from the camera is sent to the network 12, received by the terminal device 20 connected to the network 12, and displayed on the monitor 14 as is the standard surveillance image.

Thus, the user can see the skipped-back image of VGA size (having 0.31 million pixels as the amount of information). When wanting to magnify the skipped-back image displayed on the monitor 16 after checking the image, the user specifies the cut position and sends the zoom-in command together with the cut position information to the camera 1 as described in the second embodiment.

The camera 1 responds to the sent information to order the zooming-in processor 7 to zoom in the skipped-back image.

When the zoom-in factor is assumed to be four, a partial image (0.31 million pixels) corresponding to ¼ size, or VGA size (640×480) is cut from the SXGA size image area, and expanded to the standard image area size by use of the memory.

In this case, the amount of information is 0.31 million pixels, and the resolution is equivalent to the skipped-back image in the standard surveillance mode.

The output from the skipping-back memory 5 is fourfold zoomed in by the zooming-in processor 7, and supplied from the camera 1 through the selector 8 and network interface 9 to the outside.

The signal produced from the camera 1 is sent to the network 12, received by the terminal device 20 connected to the network 12, and displayed on the monitor 16. The image displayed on the monitor 16 is the image electrically zoomed in, but has the resolution equivalent to that in the standard monitoring mode so that it can be clearly checked.

Thus, according to the constructions of the first, second and third embodiments, a high-resolution image can be obtained in spite of being electrically zoomed in.

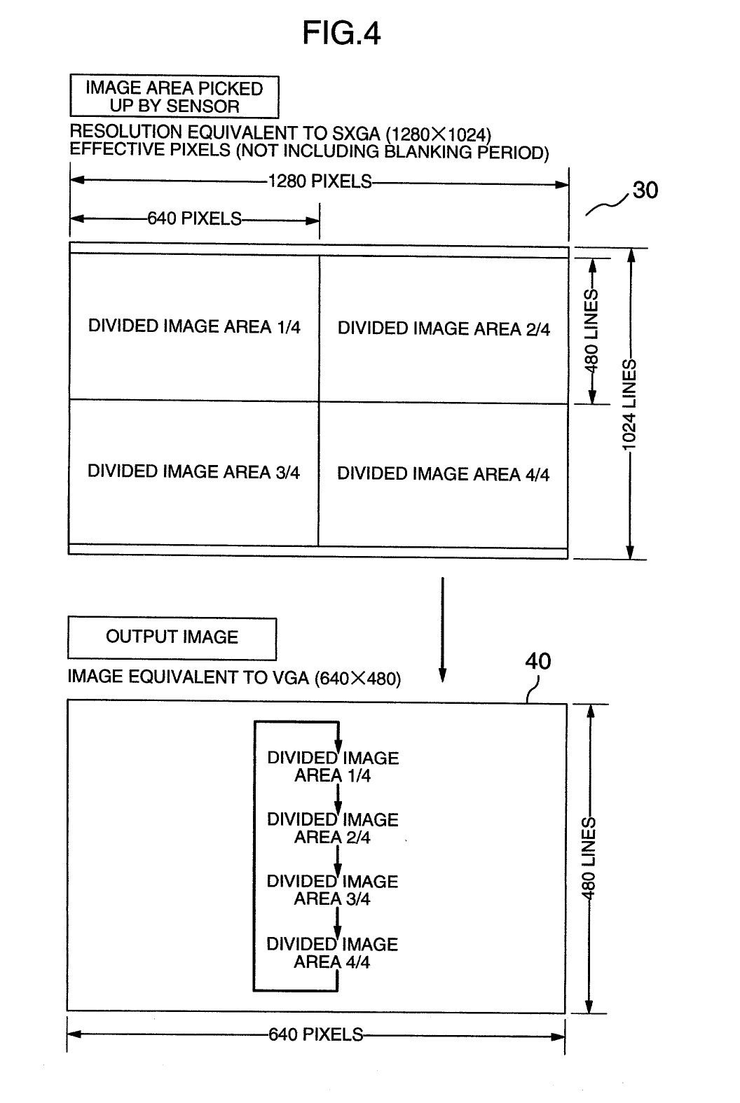

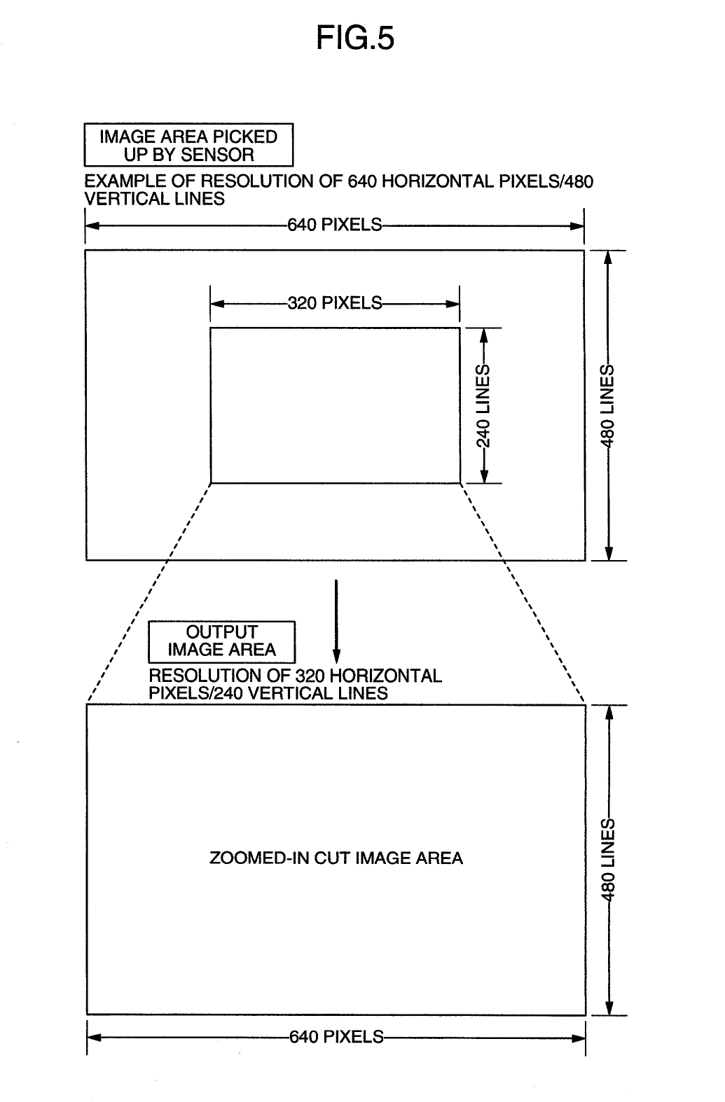

With reference to FIGS. 3 and 4, a description will be made of a method of transmitting an image signal (1.3 million pixels) of SXGA size (1280×1024) on a transmission path that is allowed to transmit only the image signal of less than VGA size.

The image sensor is here assumed to have the same SXGA size (1280×1024) as those in the first, second and third embodiments.

A partial image of VGA size (640×480) corresponding to ¼ the SXGA size is cut from the image signal of SXGA size (1280×1024) that is produced from the image sensor 3, and zoomed in fourfold. Here, it is assumed that the cut partial image is one of the four images resulting from equally dividing the image of SXGA size (1280×1024) by four as illustrated in FIG. 4 by image 30 area picked up by the sensor. These four divided images are automatically switched in turn as shown in FIG. 4 by an output image area 40, and supplied from the camera 1 to the network 12.

The method of dividing these four small image areas from the original image area and reproducing them will be further described in detail. First, the cut positions are switched every four fields. The cut positions for these four small image areas are previously determined. When one of the small image areas being cut away is cut, an identification signal of that image area is added to the divided image signal. When the divided image area is transmitted via the network 12 to the terminal 20, the positional information is added to the utility regions of packets over the whole image area, if the packets are used for transmission. On the terminal device 20 side, the mutual positional relation of the four divided images is determined on the basis of the received positional information in order to recombine into a single frame image and reproduce it. In addition, buffer memories (not shown) are provided in the terminal 20 to hold the divided image areas in the order of cutting, or in the order of divided image areas ¼, 2/4, ¾, 4/4. Also, it is assumed that the pixels in the horizontal direction (line) is numbered as 1 to 1280, and the lines in the vertical direction as 1 to 1024. To reconstruct the divided images, the buffer memories are switched every lines to read data. The range of the first line to 480th line in the vertical direction and the first pixel to 640th pixel in the horizontal direction is read as the divided image signal ¼. The next range of the first line to 480th line in the vertical direction and the 641st pixel to 1280th pixel in the horizontal direction is read as the divided image signal 2/4. In addition, the range of the 481st line to 1024th line in the vertical direction and the first pixel to 640th pixel in the horizontal direction is read as the divided image signal ¾, and the range of the 481st line to 1024th line in the vertical direction and the 641st pixel to 1280 pixel in the horizontal direction is read as the divided image signal 4/4. These divided image signals are then reproduced as the original image to be displayed.

Thus, it will be easily understood that although each of the cut image signals sent from the camera 1 to the network 12 has the amount of information corresponding to VGA size, these four images, when combined on the receiving terminal device 20, produce the finally obtained image that has the. resolution of (640×2, 480×2)=(1280×960), or SXGA size.

Therefore, if the four divided images are sequentially supplied after being switched and zoomed in, they can be each transmitted as a ¼ thinned image signal that is ¼ thinned in terms of time, or the SXGA size image signal can be virtually transmitted on the transmission path that is allowed to transmit only the image signal of VGA size or less.

Other applications of the image signal processing system and monitoring system according to the invention can be given as follows. The movement of a trespasser or the like is detected by a sensor, and the positions of the moving object are specified. The positional information of the moving object is entered in the image signal processing system, so that an image area of the position of the moving object is zoomed in. The zoomed-in image is supplied via the network to the terminal device 20. Thus, the moving trespasser can be tracked. Although a camera for tracking the trespasser is known, this employs a technique using the pan and tilt mechanism, and thus it is complex in its structure and expensive. The electric image processing zoom-in method does not need the special pan tilt mechanism, and thus can make the system be assembled at low cost. The pan tilt mechanism system has the drawback of loosing the whole image, but the system according to the invention has no such drawback since the sensor section always holds the whole image area.

Thus, according to the invention, a video surveillance system having an electrically zooming-in function can be constructed that can monitor a wide range of scene without deteriorating the picture quality since the whole, thinned-out image, and the electrically zoomed-in cut image are properly switched. Moreover, even the SXGA size image signal can be transmitted on the transmission path that is allowed to transmit only the image signal of VGA size or less since the four divided image areas are sequentially supplied after being switched and zoomed in.

It should be further understood by those skilled in the art that although the foregoing description has been made on embodiments of the invention, the invention is not limited thereto and various changes and modifications may be made without departing from the spirit of the invention and the scope of the appended claims.

What is claimed is:

1. An image signal processing system for processing image signal from a camera, comprising:
an image sensor having a first number of effective pixels; and
signal processors for processing an image signal of said first number of effective pixels generated from said image sensor to produce another image signal of a second number of effective pixels smaller than said first number of effective pixels,
said signal processors including a zooming-in processor for taking out said other image signal of a partial image region of said second number of effective pixels after being specified within said image signal of said first number of effective pixels, and outputting said image signal of said partial image region at a predetermined output rate.

2. An image signal processing system according to claim 1, wherein said signal processors further include:
a thinning-out processor for sampling said image signal of said first number of effective pixels at a certain sampling rate to produce said other image signal of said second number of effective pixels and supplying it to the following stage; and
a selector for selecting either one of the output from said thinning-out processor and the output from said zooming-in processor by switching in accordance with a switching signal, and supplying it to the following stage.

3. An image signal processing system according to claim 1, wherein said zooming-in processor takes out image signals as a plurality of previously specified partial image regions each having said second number of effective pixels from said image signal of said first number of effective pixels, and sequentially supplying said image signals of said plurality of partial image regions at a predetermined output rate.

4. An image signal processing system according to claim 2, further comprising a memory for storing a certain number of frames of said image signal of said first number of effective pixels, and rewriting the earliest frame of said stored image signal as the current frame of said image signal, said certain number of frames stored in said memory being sequentially read out in accordance with an external control signal and supplied to said thinning-out processor and said zooming-in processor.

5. An image signal processing system connected to a communication network, comprising:
an image sensor having a first number of effective pixels; and
signal processors for processing an image signal of said first number of effective pixels from said image sensor to produce another image signal of a second number of effective pixels less than said first number of effective pixels and supplying it to said communication network,
said signal processors including:
a zooming-in processor for taking out said other image signal of said second number of effective pixels as a partial image region specified within said image signal of said first number of effective pixels and supplying said image signal of said partial image region at a predetermined output rate;
a thinning-out processor for sampling said image signal of said first number of effective pixels at a certain sampling rate to produce said other image signal of said second number of effective pixels, and supplying it to the following stage; and
a selector for selecting either one of the output from said thinning-out processor and the output from said zooming-in processor by switching in accordance with a selection signal received by an external terminal device connected to said communication network.

6. An image signal processing system according to claim 5, wherein said zooming-in processor equally divides said image signal of said first number of effective pixels into a plurality of partial image regions each having said second number of effective pixels, takes out image signals of said plurality of partial image regions resulting from said equal division, and sequentially supplies them at a predetermined output rate to the following stage.

7. An image signal processing system according to claim 6, wherein said terminal sequentially reproduces said image signals of a plurality of partial image regions sent and received at said predetermined output rate from said signal processors through said communication network.

8. An image signal processing system according to claim 6, wherein said terminal device combines said image signals of a plurality of partial image regions sent and received at said predetermined output rate from said signal processors through said communication network to reproduce said image signal of said first number of effective pixels.

9. An image signal processing system according to claim 5, further comprising a memory for storing a predetermined number of frames of said signal of said first number of effective pixels, and rewriting the earliest one of said stored frames of said image signal as the current frame of said image signal, said predetermined number of frames stored in said memory being then sequentially read out in accordance with a control signal from said terminal and fed to said thinning-out processor and said zooming-in processor.

10. A video surveillance system comprising:
a camera;
a communication network connected to said camera; and
a terminal device connected to said communication network to receive an image signal from said camera and control said camera, said camera comprising:
an image sensor having a first number of effective pixels; and
signal processors for processing said image signal of said first number of effective pixels from said image sensor to produce another image signal of a second number of effective pixels less than said first number of effective pixels and supplying it to said communication network,
said signal processors including:
a zooming-in processor for taking out said image signal of said second number of effective pixels as partial image regions specified within said image signal of said first number of effective pixels, and outputting said image signal of said partial image regions at a predetermined output rate;
a thinning-out processor for sampling said image signal of said first number of effective pixels at a certain sampling rate to produce said other image signal of said second number of effective pixels, and outputting it; and
a selector for selecting either one of the output from said thinning-out processor and the output from said zooming-in processor by switching in accordance with a selection signal received from said terminal through said communication network.
